(19) United States
(12) Patent Application Publication
(10) Pub. No.: US 2019/0024912 A1
(43) Pub. Date: Jan. 24, 2019

(54) APPARATUS AND METHOD FOR DRYING AND COOLING SEEDS

(71) Applicant: MARCOLD GROUP S.R.L., Gazoldo Degli Ippoliti (IT)

(72) Inventor: Alberto Mari, Volta Mantovana (IT)

(21) Appl. No.: 15/755,706

(22) PCT Filed: Aug. 26, 2016
(86) PCT No.: PCT/IB2016/055112

§ 371 Date: Feb. 27, 2018

(30) Foreign Application Priority Data
Aug. 27, 2015 (IT) 102015000046931

(51) Int. Cl. F24F 3/14; F26B 21/00; F24F 3/153; F26B 21/08; F26B 21/10

(52) U.S. Cl. CPC F24F 3/1405; F26B 21/002; F24F 3/153; F26B 2200/06; F26B 21/10; F24F 2003/1452; F26B 21/086

(57) ABSTRACT

Apparatus (10) for drying and cooling seeds (S), comprising a container (38) for the seeds (S); a device (15) to suck in the air (Va) from the outside environment and to send it toward the seeds (S) to be dried and cooled; a first heat exchange unit (11) configured to cool the air taken from the outside environment and raise its relative humidity; a second heat exchange unit (12) configured to lower the temperature and absolute humidity of the air from the first heat exchange unit (11); and a third heat exchange unit (13) fluidically connected to the second heat exchange unit (12) to receive the cooled air exiting from the latter, and provided with a first heat exchange circuit (110) able to be selectively activated to raise the temperature and lower the relative humidity of the air passing through said third heat exchange unit (13), and able to be selectively de-activated to send the cold air coming from said second heat exchange unit (12) to the seeds (S).

### FIELD OF THE INVENTION

The present invention concerns processes for treating and preserving seeds, and in particular an apparatus and method for drying/cooling and refrigerating/preserving seeds, by treating the air that is taken from an environment, generally an outside environment, and used for a first drying step of the seeds and a subsequent step of cooling and preserving them.

### BACKGROUND OF THE INVENTION

As is known, the seeds of new plants, such as for example the seeds of corn, wheat, cereals, soya or suchlike, are collected a certain time before their normal harvesting period, so as to maintain a high capacity for germination. Such seeds therefore have a higher relative humidity than the value required for a classical preservation, for example even five or six percentage points. Normally, after harvesting, the seeds are poured into suitable containers or silos, in which, given their high relative humidity rate, they must be subjected to drying processes so as to take their temperature and relative humidity to correct values for optimum preservation. The values of humidity and temperature inside the silos must be monitored constantly. The purpose of the drying processes is therefore to reduce humidity inside the seeds so as to prevent the development of pathogenic phenomena or agents that are harmful and deleterious for germination.

Current plants that are used for these processes for drying seeds often need complex process sequences (drying followed by cooling using fans) that are not very effective and are wasteful with regard to energy consumption.

The drying step as currently performed mainly provides two different methods:
using a burner that heats the air taken in by the ensoufflage fans in the treatment silos;
using a dryer independent of the silos and equipped with its own heating and ventilation systems.

The first method has obvious difficulties in controlling the process since it is not able to intervene effectively on the variations in the thermo-hygrometric conditions of the outside environment and hence on the overall quality of the process, and is only able to control the launch temperature, but not the humidity. An example of this solution is described in U.S. Pat. No. 6,209,223.

On the contrary, compared to the method described above, using the dryer allows a more refined control of the drying process, but on the other hand it requires a subsequent movement inside the cooling silos. Moreover, like the burner, the dryer requires a cooling process that normally provides ventilation with external air.

Often, considering the seasonal nature of the drying process, the air taken from the outside environment by the fans and sent to the treatment silos has temperature and relative humidity values that are unsuitable for obtaining an effective cooling without the risk of altering the result obtained by the drying process.

On the contrary, using traditional refrigeration machines allows to lower the relative humidity of the seeds by one or two percentage points at most, and therefore it is not possible to obtain optimal relative humidity values for treating the seeds; for this reason, it is only applied in the terminal cooling and conservation step of the seeds.

In order to effectively lower the humidity of the seeds and to allow them to be correctly preserved, the air taken in from the outside and exiting from the machines or drying plants located upstream of the preserving silos must therefore have a temperature and relative humidity suitable for an effective drying treatment. Temperature and humidity values suitable for an effective drying treatment for the seeds are for example a temperature comprised between about 30° C. and about 35° C. and a relative humidity of about 30-40% and preferably about 35%.

A modular apparatus with a heat pump is also known from document WO-A-00/36344, for drying and treating the air used for example for drying industrial or agricultural products.

This apparatus comprises a drying chamber in which the products to be dried are inserted, the drying chamber is in fluidic communication with an air drying circuit. The air drying circuit comprises a first array of heat exchangers configured to cool the air that passes through them and to partly heat it, and a second array of heat exchangers located downstream and provided to regulate the temperature of the air treated by the first array of heat exchangers and to feed it to the drying chamber.

Between the first and second array of heat exchangers a fan is interposed, provided to generate a flow of suction air through the first array of heat exchangers, and to generate a flow of pressing air through the second array of heat exchangers. This solution, however, is particularly ineffective due to the high turbulence and load losses that are generated at least in the second array of heat exchangers and which drastically reduce the efficiency of the whole drying apparatus.

Furthermore, in this solution, the drying circuit has a substantially closed cycle, except for some air feed shutters that can possibly be opened. In fact, in this solution, the flow of air exiting from the drying chamber is completely re-circulated through the first array of heat exchangers and takes with it a high quantity of humidity, which is usually much higher than that of ambient air. This therefore requires high heat exchange powers with a considerable waste of energy.

Purpose of the present invention is therefore to obtain an apparatus for drying and cooling seeds that allows to obtain an effective and long-lasting preservation of the seeds directly in the silos in which the seeds are poured and contained, and therefore which is able to take the seeds with a single machine to the correct temperature and relative humidity values, both in a drying step and in a subsequent cooling step.

Another purpose of the present invention is to obtain a process for drying and cooling seeds able to control in a refined manner the thermo-hygrometric parameters of the treatment air, guaranteeing the optimum temperature and relative humidity values required by the various seeds absolutely independently of the outside environment conditions.

Another purpose of the present invention is to obtain an apparatus for drying and cooling seeds that allows an automatic regulation of the drying air to be supplied to the seeds and that is advantageous from the point of view of saving energy.

Another purpose of the present invention is to perfect a method for drying and cooling seeds that is efficient and allows to perform an optimal thermo-hygrometric treatment of the seeds, able to guarantee a high degree of germination of the same.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, an apparatus for drying and cooling seeds according to the present invention comprises:

a container to contain the seeds,

a device to suck in the air from the outside environment and to send it toward the seeds to be dried and cooled,

a first heat exchange unit in which, on one side, the air taken from the outside environment flows and, on the other side, a heat exchange fluid flows, the first heat exchange unit being configured to pre-cool the air and raise its relative humidity, arriving, in determinate conditions and merely by way of example, indicatively to dew point,

a second heat exchange unit in which, on one side, the air exiting from the first heat exchange unit flows and, on the other side, a cooling fluid flows, different from the heat exchange fluid of the first heat exchange unit, the second heat exchange unit being configured to further lower the temperature of the air and to condense part of the humidity contained therein;

a third heat exchange unit fluidically connected to the second heat exchange unit to receive the cooled air exiting from the latter, and provided with a first heat exchange circuit in which a heat exchange fluid flows, the first heat exchange circuit being able to be selectively activated in a first functioning mode of the apparatus in order to raise the temperature of the air and lower the relative humidity of the air passing through the third heat exchange unit, so as to obtain an effective drying of the seeds and able to be selectively de-activated in a second functioning mode of the apparatus, in order to send the cold air coming from the second heat exchange unit to the seeds and obtain an effective cooling thereof.

According to possible embodiments of the present invention, the first heat exchange unit and the third heat exchange unit are both associated with the first heat exchange circuit in which a single heat exchange fluid flows configured to respectively pre-cool the air that passes through the first heat exchange unit and to heat the air that passes through the third heat exchange unit.

According to one aspect of the present invention, the suction device of the air is fluidically and directly connected to an introduction aperture of the container and is positioned downstream of the third heat exchange unit in order to generate a suction flow of the air from the outside environment through the first heat exchange unit, the second heat exchange unit and the third heat exchange unit, and to introduce the air into the seed container.

This position of the suction device is particularly effective to generate a flow of air, extremely uniform and homogeneous, through the first heat exchange unit, the second heat exchange unit and the third heat exchange unit.

This allows to optimize the heat exchange processes between the air and the heat exchange fluids and the cooling fluid, obtaining air with a high capacity for drying or cooling the seeds.

At least one of either the first, the second, or the third heat exchange unit can comprise a first part of heat exchange circuit in which the cooling fluid or the heat exchange fluids are made to circulate and a second part of heat exchange circuit in which the air to be dried is made to transit. The second parts of the heat exchange circuits are reciprocally connected to each other.

The apparatus can also provide a fourth heat exchange unit located downstream of the third heat exchange unit and in which on one side, a heat exchange fluid flows and, on the other side, the air exiting from the third heat exchange unit flows; the fourth heat exchange unit is configured to raise the temperature of the air exiting from the third heat exchange unit and to lower its relative humidity, both during the drying functioning mode and during the functioning mode to cool and preserve the seeds.

Advantageously, using the present apparatus for drying and cooling seeds, it is possible to obtain an effective and optimal treatment of the seeds inside the silos, thanks to a process performed with air that has optimal values of temperature and relative humidity, suitable to lower even by 5 or 6 percentage points the humidity of the seeds contained in the silos; moreover, using the present apparatus, it is possible to continue with a subsequent cooling step of the seeds that can be performed substantially excluding the functioning of the third heat exchange unit.

The air fed to the seed container and used for drying has preferably and advantageously a temperature of about 30-35° C. and a relative humidity of about 30-40% and preferably about 35%.

Embodiments of the present invention also concern a method for drying and cooling seeds that provides to fill at least one container with the seeds, to generate a flow of air to send to the container to dry and cool the seeds by means of a suction device, the flow of air being sucked from the outside environment and made to pass through:

a first heat exchange unit in which the air is cooled and its relative humidity raised, for example indicatively to dew point,

a second heat exchange unit in which the temperature and absolute humidity of the air are lowered; and through

a third heat exchange unit provided with a first heat exchange circuit selectively able to be activated in a first functioning mode of drying the seeds, in order to raise the temperature and lower the relative humidity of the air passing through the third heat exchange unit, and able to be selectively de-activated in a second functioning mode of cooling the seeds, in order to send cold air coming from the second heat exchange unit to the seeds.

According to one aspect of the method, the suction device of the air is fluidically and directly connected to an introduction aperture of the container and is positioned downstream of the third heat exchange unit and generates a suction flow of the air from the outside environment through the first heat exchange unit, the second heat exchange unit and the third heat exchange unit, and introduces the air into the seed container.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a block diagram of an apparatus for drying and cooling seeds according to the present invention;

FIG. 2 is a psychrometric diagram showing the values of temperature and humidity of the air in some treatment steps, in order to take it to a suitable temperature and suitable percentage of relative humidity.

To facilitate comprehension, the same reference numbers have been used, where possible, to identify identical common elements in the drawings.

### DETAILED DESCRIPTION OF SOME EMBODIMENTS

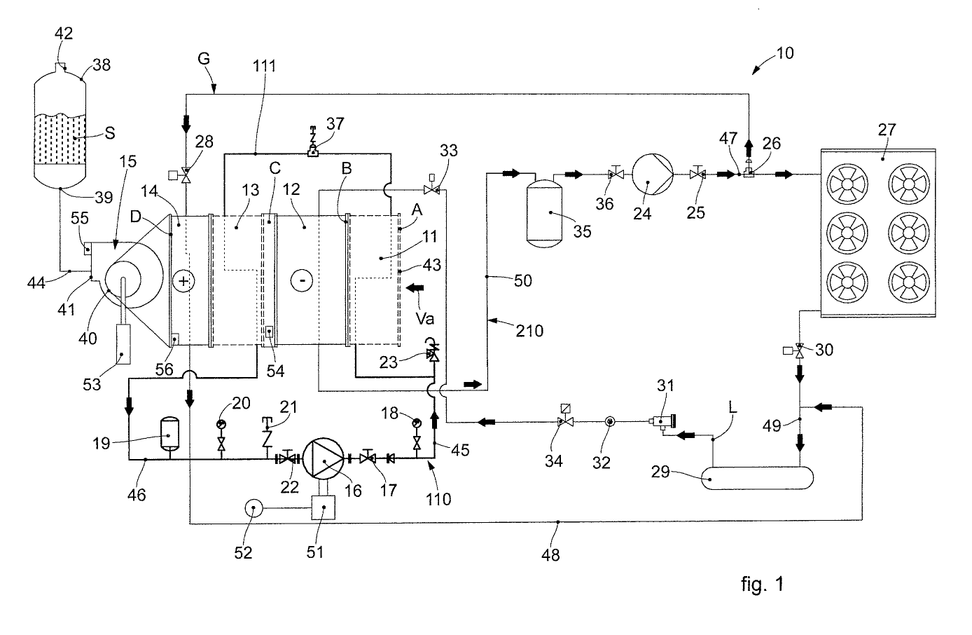

With reference to the attached drawings and in particular to FIG. 1, the number 10 denotes an apparatus for drying and cooling seeds S according to the present invention.

The apparatus 10 comprises a battery of elements located in sequence with one another: a first heat exchange unit 11, for example a heat exchanger, associated with a first heat exchange circuit, in this specific case a water circuit 110; a second heat exchange unit, for example an evaporator 12 of a second heat exchange circuit, in this specific case a cooling circuit 210; a third heat exchange unit 13, for example a heat exchanger, also associated in the case shown here with the water circuit 110.

According to a possible solution, the apparatus 10 can also comprise a fourth heat exchange unit 14, for example a heat exchanger.

Downstream of the fourth heat exchange unit 14 a suction device 15 is connected, to suck in the external air Va which is made to pass through the battery of elements described above.

The air suction device 15 can be for example a centrifuge fan. According to possible solutions, the suction device 15 can be connected to a regulation member 53 configured to regulate the flow rate of air that is made to transit through the battery of elements described above.

The drying apparatus 10 comprises a container 38, for example a silo for containing seeds S, into which the air sucked in and treated will be introduced. The container 38 is located downstream of the air suction device 15 and the humidity and temperature inside it will be constantly monitored and controlled, so as to automatically regulate the parameters of relative humidity and temperature of the air exiting from the apparatus 10.

The container 38 is provided with an air introduction aperture 39 fluidically and directly connected to the suction device 15.

In this way, by activating the suction device 15, it is possible to generate a suction flow of air Va from the outside environment through the first heat exchange unit 11, the second heat exchange unit 12, the third heat exchange unit 13 and possibly, if present, the fourth heat exchange unit 14.

The position of the suction device 15 downstream of the first 11, second 12, third 13 and possible fourth 14 heat exchange unit allows to improve the uniformity of speed of air through all these heat exchange units, for example through possible finned batteries present. The positioning prevents phenomena of turbulence generated by positive pressure gradients and due to the slow-down of the air to the delivery of the suction device 15.

The suction device 15 can comprise a suction aperture 40 fluidically connected to the third heat exchange unit 13 or the possible fourth heat exchange unit 14 if present, and a delivery aperture 41 connected directly to the introduction aperture 39 of the container 38 for seeds S.

The container 38 can in turn be provided with a vent aperture 42, open directly toward the outside and through which the air Va introduced into the container 38, after having passed through the seeds S, is released directly into the outside environment.

The air exiting from the container 38, in fact, is rich in humidity removed from the seeds S: any subsequent treatment thereof, or recirculating to remove the humidity, would be disadvantageous in terms of energy. This solution, which embodies an open-ring circuit for the air, allows to increase the efficiency of the apparatus 10 compared with known solutions.

The first heat exchange unit 11 is provided with an entrance aperture 43, separate and independent from the vent aperture 42, through which the air sucked in by the suction device 15 enters into the first heat exchange unit 11.

According to another aspect of the present invention, between the entrance aperture 43 of the first heat exchange unit 11 and the vent aperture 42 of the container 38 an open circuit 44 is defined for the passage of the air, which comprises the first heat exchange unit 11, the second heat exchange unit 12, the third heat exchange unit 13, the possible fourth heat exchange unit 14, the suction device 15 and the container 38. By open circuit 44 for the passage of the air we mean that the air sucked in from outside through the entrance aperture 43 is again introduced into the outside environment through the vent aperture 42.

According to another aspect of the present invention, the third heat exchange unit 13 is provided with the water circuit 110 in which a heat exchange fluid flows, in this specific case water, although it is not excluded that other heat exchange fluids can be used. The water circuit 110 is able to be selectively activated in a first functioning mode of the apparatus 10, to raise the temperature and lower the relative humidity of the air passing in the third heat exchange unit 13, and can be selectively de-activated, in a second functioning mode of the apparatus 10, to send the cold air arriving from the second heat exchange unit 12 to the seeds S without heating it again.

According to a possible solution of the present invention, the first heat exchange unit 11 and the third heat exchange unit 13 are both associated with the water circuit 110 in which a single heat exchange fluid flows, in this specific case water, which is configured to respectively pre-cool the air that passes in the first heat exchange unit 11 and to heat the air that passes in the third heat exchange unit 13. In this way, the water fed to the first heat exchange unit 11, to pre-cool the air, absorbs the heat from it and heats up. Subsequently, the water passing into the third heat exchange unit 13 gives up heat to the air cooled by the second heat exchange unit 12, increasing the temperature of the air which in the meantime has been dehumidified.

The water circuit 110 comprises a pump 16 for recirculating the water, a feed branch 45 connected between the pump 16 and the first heat exchange unit 11, a connection branch 111 connected between the first heat exchange unit 11 and the third heat exchange unit 13, and a closing branch 46 that connects the third heat exchange unit 13 to the suction of the pump 16.

According to a possible solution, the feed branch 45 is provided with a first valve 17, for example a butterfly valve, located downstream of the recirculating pump 16; a first pressure measuring unit 18, for example a manometer with a corresponding tap and a safety valve 23.

According to a possible solution, the pump 16 is provided with an actuation member 51 provided to drive the pump 16, and with a regulation device 52 configured to regulate the drive speed of the pump 16. The regulation device 52 therefore allows to regulate the flow rate of water fed to the first heat exchange unit 11 and the third heat exchange unit 13, thus obtaining a regulation of the heat exchangers that occur in the latter.

According to possible solutions, the actuation member 51 can comprise an electric motor, a pneumatic motor or a hydraulic motor. According to possible alternative embodiments, the regulation device 52 can comprise an inverter for an electric motor, valves to regulate a flow for a pneumatic motor or a hydraulic motor.

According to another solution, the connection branch 111 can be provided with a breather valve 37.

According to another solution, the closing branch 46 can be provided with an expansion chamber 19, located upstream of the pump 16 and upstream of a second pressure measuring unit 20 of a connection unit 21 for loading the water, and a second valve 22, for example a butterfly valve.

Glycol can possibly be added to the water circulating in the water circuit 110.

A suitable cooling gas flows in the cooling circuit 210, for example R134a.

The cooling circuit 210 is associated at least with the second heat exchange unit 12, in this specific case also with the fourth heat exchange unit 14.

According to possible solutions of the present invention, the cooling circuit 210 comprises, connected in series with each other, a compressor 24 to compress the cooling gas, a condenser 27 to condense the cooling gas, a rolling valve 33 in which the cooling gas is expanded, and the second heat exchange unit 12 functioning as an evaporator.

According to a possible solution, in a first connection pipe 47 between the compressor 24 and the condenser 27, a gas line G is connected, configured to feed at least part of the cooling gas compressed by the compressor 24 to the fourth heat exchange unit 14.

The first connection pipe 47 can be provided for this purpose with a branch 26, configured to allow to feed the gas to the condenser 27 and/or to the gas line G.

The first connection pipe 47 is provided, at the feed circuit of the compressor 24, with a manual interception valve 25, located upstream of the branch 26.

The compressed gas fed to the fourth heat exchange unit 14 has a high temperature and, passing through the latter, heats the air circulating therein.

The gas line G is also provided with a closing pipe 48 that connects the fourth heat exchange unit 14 to a second connection pipe 49 provided to connect the condenser 27 and the rolling valve 33.

In the second connection pipe 49, upstream of the connection point of the closing pipe 48, a valve 30 is installed to regulate the pressure, suitable to properly regulate the pressure of the fluid in the second connection pipe 49 and determine the flow rate through the condenser 27 and through the fourth heat exchange unit 14. Generally, the pressure regulation valve 30 is suitable to promote the flow arriving from the fourth heat exchange unit 14.

According to a possible solution, the first connection pipe 47, between the compressor 24 and the condenser 27, is provided with a manual interception valve on the delivery circuit of the compressor 24.

The gas line G can be provided with a valve 28 located upstream of the fourth heat exchange unit 14, for example a solenoid valve configured to regulate the flow of gas fed to the fourth heat exchange unit 14.

The cooling circuit 210 can also comprise, upstream of the rolling valve 33, a receptacle 29 for the coolant arriving from the fourth heat exchange unit 14 and from the condenser 27.

The cooling circuit 210 can also comprise, downstream of the receptacle 29 for the coolant, a liquid line L provided with a filter 31, an optical indicator 32 for the level of liquid, a solenoid valve 34 and said rolling valve 33, for example an electronic thermostatic valve. The liquid line L connects in turn to the second heat exchange unit 12.

The cooling circuit 210 also comprises a suction branch 50 connected between the second heat exchange unit 12 and the compressor 24 and through which the gas exiting from the second heat exchange unit 12 is sucked in by the compressor 24, having possibly passed in a coolant separator 35, able to prevent parts of cooling fluids in a liquid state from reaching the compressor 24.

Upstream of the compressor 24 there is a manual interception valve 36.

In the drying and cooling apparatus 10 according to the present invention probes are also provided: a first probe 54 for managing the cooling power and speed of the suction device 15 is positioned between the second heat exchange unit 12 and the third heat exchange unit 13; a humidity probe 55 is located downstream of the suction device 15 and manages the valve 28 that feeds the hot gas into the post-heating fourth heat exchange unit 14; and a temperature probe 56 is located downstream of the fourth heat exchange unit 14 to limit the maximum temperature of the air acting on the valve 28 that feeds the hot gas.

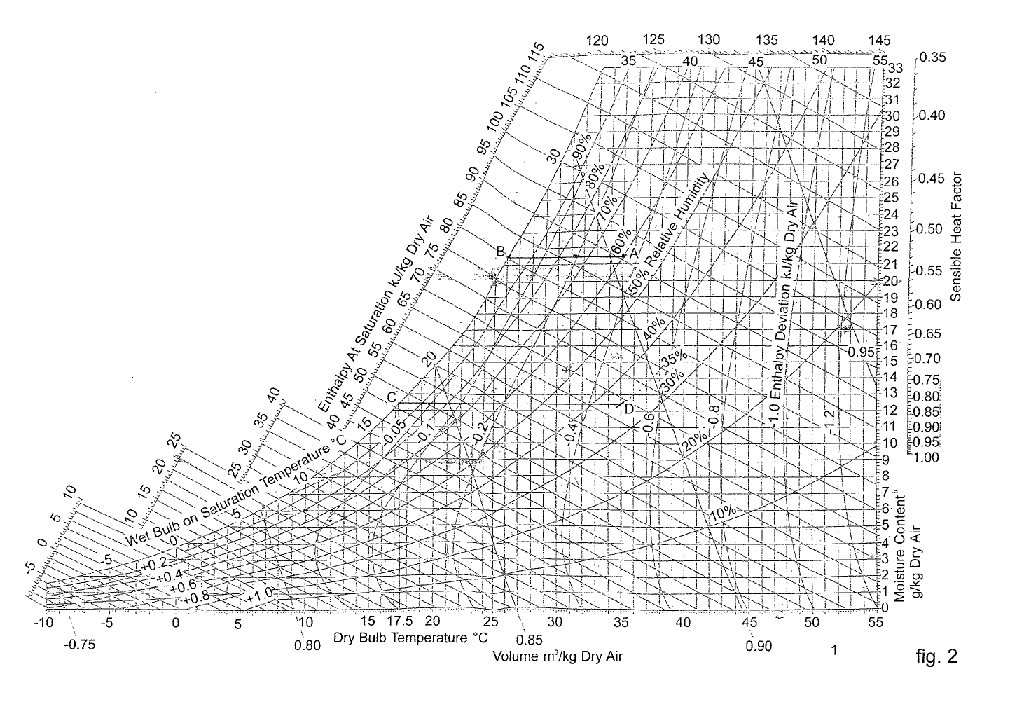

FIG. 2 shows an example of a psychometric diagram that shows the conditions of temperature and relative humidity of the air Va at entrance to the drying apparatus 10, hence the conditions indicated in point A, the intermediate conditions B and C inside the apparatus 10, and the conditions of temperature and relative humidity of the drying air at exit, that is, the conditions of the air at point D.

When the apparatus 10 according to the present invention is activated to dry the seeds S, the pump 16 for re-circulating the water is activated together with the suction device 15 of the air Va. Supposing that the air Va enters through the first heat exchange unit 11 at a temperature of about 35° C. and with a relative humidity of 60%, in a first step A-B the air Va is cooled to a temperature of about 26° C., reaching dew point, hence with humidity at 100%, point B in the diagram. The first step A-B is concluded in the first heat exchange unit 11 by water arriving from the water circuit 110. The first heat exchange unit 11 can be for example a finned battery with pipes and fins keyed on the pipes. Inside the pipes the water arriving from the water circuit 110 flows, while outside, to lap the fins, the flow of air Va is made to transit.

From the first heat exchange unit 11, as we said, the air exits in condition B, while the water exits at a higher temperature than that at entry, and is introduced through the connection branch 111 into the third heat exchange unit 13. The third heat exchange unit 13 can also be for example a finned battery with pipes and fins. Inside the pipes the hot water arriving from the connection branch 111 flows, while the air arriving from the second heat exchange unit 12 flows on the fins.

The air, with thermo-hygrometric characteristics defined by point B, is made to pass through the second heat exchange unit 12 of the cooling circuit 210, so that its temperature is lowered to the conditions defined in point C, step B-C. At point C, humid, saturated and cold air is substantially obtained, and the formation of a portion of condensation eliminated through a suitable discharge pipe present on the apparatus 10.

After this step of lowering the temperature and absolute humidity, the air, at the condition defined at point C, is introduced into the third heat exchange unit 13. The air is subjected to a first heating in the third heat exchange unit 13, then it is made to pass through the fourth post-heating heat exchange unit 14, where it is subjected to a second heating which takes it to a final value, condition D, of about 35° C. and a relative humidity of about 35%.

This condition of the air at point D of the diagram in FIG. 2 is optimal for drying the seeds S, therefore the air can be sent by means of the suction device 15 into the container 38 where the seeds S are contained.

The fourth heat exchange unit 14 can intervene both in the drying step and in the cooling step of the seeds S, while the third heat exchange unit 13 can be de-activated in the cooling step of the seeds S.

By suitably sizing the parameters for making the first and third heat exchange unit 11 and 13, the heating step in the fourth heat exchange unit 14 could be optional, also as a function of the values of temperature and humidity of the air to be obtained by the apparatus 10.

Inside the first and third heat exchange unit 11 and 13, moreover, the water could be replaced by another treatment fluid which, in a first step and in the first heat exchange unit 11 has the function of taking the air to dew point and, in a subsequent step, has the function of a heating fluid, in the third heat exchange unit 13.

The portion of hot gas removed by the branch 26 upstream of the condenser 27 will be chosen on each occasion as a function of the desired heating to be obtained by said hot gas, and hence as a function of the temperature of the air and the relative humidity of the drying air exiting from the fourth heat exchange unit 14.

The present apparatus 10 can also be advantageously used to perform a subsequent step to cool and regulate the temperature of the seeds S in the containing silo or silos. In this case, only the parts of the apparatus that lower the temperature and the absolute humidity of the air can be used, for example the second heat exchange unit 12, therefore excluding the first and third heat exchange unit 11, 13.

It is clear that modifications and/or additions of parts may be made to the apparatus 10 and method as described heretofore, without departing from the field and scope of the present invention.

It is also clear that, although the present invention has been described with reference to some specific examples, a person of skill in the art shall certainly be able to achieve many other equivalent forms of apparatus, having the characteristics as set forth in the claims and hence all coming within the field of protection defined thereby.

1. Apparatus for drying and cooling seeds (S), comprising:
a container to contain said seeds (S),
a device to suck in the air (Va) from the outside environment and to send it toward the seeds (S) to be dried and cooled,
a first heat exchange unit in which, on one side, the air (Va) drawn from the outside environment flows and, on the other side, a heat exchange fluid flows, said first heat exchange unit being configured to cool the air and raise its relative humidity,
a second heat exchange unit in which, on one side, the air exiting from said first heat exchange unit flows and, on the other side, a cooling fluid flows, different from said heat exchange fluid, said second heat exchange unit being configured to lower the temperature and absolute humidity of the air;
a third heat exchange unit fluidically connected to said second heat exchange unit to receive the cooled air exiting from the latter, and provided with a first heat exchange circuit in which a heat exchange fluid flows, said first heat exchange circuit being able to be selectively activated in a first functioning mode of the apparatus, in order to raise the temperature and lower the relative humidity of the air passing through said third heat exchange unit, and able to be selectively de-activated in a second functioning mode of the apparatus, in order to send the cold air coming from said second heat exchange unit to the seeds (S), wherein said suction device of the air (Va) is fluidically and directly connected to an introduction aperture of said container and is positioned downstream of said third heat exchange unit in order to generate a suction flow of the air (Va) from the outside environment through said first heat exchange unit, said second heat exchange unit and said third heat exchange unit, and to introduce said air (Va) into said container.

2. Apparatus as in claim 1, wherein said container is provided with a vent aperture, open directly toward the outside and through which the air (Va) introduced into said container, after having passed through the seeds (S), is directly released into the outside environment.

3. Apparatus as in claim 1, wherein said first heat exchange unit and said third heat exchange unit are both associated with said first heat exchange circuit in which a single heat exchange fluid transits, configured to respectively pre-cool the air that passes through said first heat exchange unit and to heat the air that passes through said third heat exchange unit.

4. Apparatus as in claim 3, wherein said first heat exchange circuit comprises a pump to recirculate said heat exchange fluid, a feed branch connected between said pump and said first heat exchange unit, a connection branch connected between said first heat exchange unit and said third heat exchange unit, and a closing branch that connects said third heat exchange unit to the suction of said pump.

5. Apparatus as in claim 4, wherein said pump is provided with an actuation member provided to drive said pump and a regulation device configured to regulate the drive speed of the pump and the flow rate of heat exchange fluid through the first heat exchange circuit.

6. Apparatus as in claim 1, further comprising a fourth heat exchange unit located downstream of the third heat exchange unit and in which on one side a heat exchange fluid flows and, on the other side, the air exiting from said third heat exchange unit flows, said fourth heat exchange unit being configured to raise the temperature of the air exiting from said third heat exchange unit and to lower its relative humidity, both during the drying functioning mode and also during the functioning mode to cool and preserve the seeds (S).

7. Apparatus as in claim 1, wherein said second heat exchange unit comprises an evaporator of a cooling circuit.

8. Apparatus as in claim 6, wherein said cooling circuit comprises, connected in series with each other, a compressor, a condenser, a rolling valve, and said second heat exchange unit, in that, in a first connection pipe between said compressor and said condenser, a gas line (G) is connected configured to feed at least part of the cooling fluid compressed by said compressor to said fourth heat exchange unit, and said gas line (G) is provided with a closing pipe that connects said fourth heat exchange unit to a second connection pipe provided between said condenser and said rolling valve.

9. Apparatus as in claim 8, further comprising a pressure regulation valve suitable to regulate properly the pressure in said second connection pipe and to determine the flow rate through said condenser or through said fourth heat exchange unit installed in said second connection pipe, upstream of the connection point of the closing pipe.

10. Method for drying and cooling seeds (S) that provides to fill a container with said seeds (S), to generate a flow of air (Va) to be sent to said container to dry and cool said seeds (S) by means of a suction device, said flow of air (Va) being sucked from the outside environment and made to pass through:
a first heat exchange unit in which the air (Va) is cooled and its relative humidity raised,
a second heat exchange unit in which the temperature and absolute humidity of the air (Va) are lowered; and through
a third heat exchange unit provided with a first heat exchange circuit able to be selectively activated in a first functioning mode of drying the seeds (S), in order to raise the temperature and lower the relative humidity of the air (Va) passing through said third heat exchange unit, and able to be selectively de-activated in a second functioning mode of cooling the seeds (S), in order to send the cold air coming from said second heat exchange unit to said seeds (S), wherein the suction device of the air (Va) is fluidically and directly connected to an introduction aperture of said container and is positioned downstream of said third heat exchange unit and generates a suction flow of the air (Va) from the outside environment through said first heat exchange unit, said second heat exchange unit and said third heat exchange unit, and introduces said air (Va) into said container.

11. Method as in claim 10, wherein the air introduced into said container, after having passed through said seeds (S), is released directly into the outside environment.

12. Method as in claim 10, wherein said first heat exchange unit and said third heat exchange unit are both associated with said first heat exchange circuit in which a single heat exchange fluid is made to flow to pre-cool the air (Va) that passes through said first heat exchange unit and to heat the air (Va) that passes through said third heat exchange unit.

13. Method as in claim 10, wherein, before being introduced into said container, the air (Va) is made to pass through a fourth heat exchange unit located downstream of the third heat exchange unit in order to raise the temperature of the air exiting from said third heat exchange unit and to lower its relative humidity.

14. Method as in claim 10, wherein the air (Va) fed to said container and used to dry the seeds (S) has a temperature of about 30-35° C. and a relative humidity of about 30-40%, and preferably of about 35%.

15. Apparatus as in claim 7, wherein said cooling circuit comprises, connected in series with each other, a compressor, a condenser, a rolling valve, and said second heat exchange unit, in a first connection pipe between said compressor-and said condenser, a gas line (G) is connected configured to feed at least part of the cooling fluid compressed by said compressor-to said fourth heat exchange unit, and said gas line (G) is provided with a closing pipe that connects said fourth heat exchange unit to a second connection pipe provided between said condenser and said rolling valve.

16. Apparatus as in claim 15, further comprising a pressure regulation valve suitable to regulate properly the pressure in said second connection pipe and to determine the flow rate through said condenser or through said fourth heat exchange unit is installed in said second connection pipe, upstream of the connection point of the closing pipe.
